(19) United States
(12) Patent Application Publication
(10) Pub. No.: US 2026/0299471 A1
(43) Pub. Date: Oct. 1, 2026

(54) FIXING DEVICE AND IMAGE FORMING APPARATUS

(71) Applicant: FUJIFILM Business Innovation Corp., Tokyo (JP)

(72) Inventors: Yasushi NAGATA, Kanagawa (JP); Takashi OHASHI, Kanagawa (JP); Takuma ISHIHARA, Kanagawa (JP); Motoharu NAKAO, Kanagawa (JP); Hina SAITO, Kanagawa (JP)

(73) Assignee: FUJIFILM Business Innovation Corp., Tokyo (JP)

(21) Appl. No.: 19/296,958

(22) Filed: Aug. 12, 2025

(30) Foreign Application Priority Data
Mar. 25, 2025 (JP) 2025-050526

(51) Int. Cl. G03G 15/20; G03G 15/00

(52) U.S. Cl. CPC G03G 15/2053; G03G 15/205; G03G 15/2064; G03G 15/6573; G03G 15/6585; G03G 2215/00413

(57) ABSTRACT

A fixing device includes a first fixing section that has an endless section that rotates, a support section which is disposed to correspond to a fixing region through which a medium passes and which supports the endless section, and a heating section which heats the fixing region to increase a temperature of the fixing region to a fixing temperature determined in advance and a second fixing section that has a facing section which is pressed against the support section with the endless section nipped between the facing section and the support section in the fixing region, in which a groove is formed in a support surface of the support section on a fixing region side along a width direction of the medium.

### CROSS-REFERENCE TO RELATED APPLICATIONS

This application is based on and claims priority under 35 USC 119 from Japanese Patent Application No. 2025-050526 filed Mar. 25, 2025.

### BACKGROUND

### Technical Field

The present invention relates to a fixing device and an image forming apparatus.

### Related Art

Techniques disclosed in JP2019-101314A ([0038] to [0047], [0055] to [0086], and FIG. 3 and FIGS. 6-11) and JP2016-177208A ([0020] to [0052] and FIGS. 2 - 6) to be described below are well known with regard to a fixing device that heats and fixes an unfixed image on a surface of a medium in an image forming apparatus.

JP2019-101314A ([0038] to [0047], [0055] to [0086], and FIG. 3 and FIGS. 6 - 11) describes a fixing device in which a pressing member (620) and a pressurizing roller (640) are disposed to face each other with a fixing belt (630) nipped therebetween. In JP2019-101314A ([0038] to [0047], [0055] to [0086], and FIG. 3 and FIGS. 6 - 11), it is described that glossiness of a fixed image is enhanced by setting a pressure distribution of a fixing nip portion in a sheet passing direction is maximum on an inlet side in the sheet passing direction.

JP2016-177208A ([0020] to [0052] and FIGS. 2 -6) describes a fixing device in which a fixing roll (611) and a pressurizing roll (62) are disposed to face each other with a fixing belt (610) nipped therebetween. In JP2016-177208A ([0020] to [0052] and FIGS. 2 - 6), a peeling pad (64) is disposed at a position inside the fixing belt (610) and on a downstream side of the fixing roll (611) in a nip portion (N). It is described that a position of the peeling pad (64) is switched according to the thickness of a sheet (P) to suppress an increase in gloss of thick paper.

### SUMMARY

Aspects of non-limiting embodiments of the present disclosure relate to a fixing device and an image forming apparatus that improve glossiness of an image compared to a case where a surface of a support section, which supports an endless section, on a fixing region side is smooth.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, in order to address the technical problem, there is provided a fixing device including a first fixing section that has an endless section that rotates, a support section which is disposed to correspond to a fixing region through which a medium passes and which supports the endless section, and a heating section which heats the fixing region to increase a temperature of the fixing region to a fixing temperature determined in advance and a second fixing section that has a facing section which is pressed against the support section with the endless section nipped between the facing section and the support section in the fixing region, in which a groove is formed in a support surface of the support section on a fixing region side along a width direction of the medium.

### BRIEF DESCRIPTION OF THE DRAWINGS

Exemplary embodiment(s) of the present invention will be described in detail based on the following figures, wherein:

FIG. 1 is an overall explanatory view of an image forming apparatus according to Example 1 of the present invention;

FIG. 2 is an enlarged view of a fixing device of Example 1;

FIG. 3 is an enlarged view of a major part of a portion of a support section of Example 1;

FIG. 4 is a view of the support section of Example 1 viewed from an arrow IV direction;

FIGS. 5A and 5B are explanatory views of a pressure distribution in a fixing region of Example 1, FIG. 5A is an explanatory view of a pressure distribution of a configuration of the related art, and FIG. 5B is an explanatory view of a pressure distribution of Example 1;

FIGS. 6A and 6B are explanatory views of a position of the support section of Example 1, FIG. 6A is an explanatory view of a high glossiness position, and FIG. 6B is an explanatory view of a non-high glossiness position;

FIG. 7 is a graph showing a relationship between the amount of deformation of a developer in a fixing region of Example 1 and a position in the fixing region in a transport direction; and

FIGS. 8A - 8D are explanatory views of modification examples of Example 1, FIG. 8A is an explanatory view of Modification Example 1, FIG. 8B is an explanatory view of Modification Example 2, FIG. 8C is an explanatory view of Modification Example 3, and FIG. 8D is an explanatory view of Modification Example 4.

### DETAILED DESCRIPTION

Examples as specific examples of an exemplary embodiment of the present invention will be described below with reference to the drawings, but the present invention is not limited to Examples to be described below.

In order to facilitate the understanding of the following description, in the drawings, a front-rear direction will be referred to as an X-axis direction, a right-left direction will be referred to as a Y-axis direction, and an up-down direction will be referred to as a Z-axis direction. Directions or sides indicated by arrows X, -X, Y, -Y, Z, and -Z will be defined as a forward direction, a rearward direction, a rightward direction, a leftward direction, an upward direction, and a downward direction, or a front side, a rear side, a right side, a left side, an upper side, and a lower side, respectively.

In addition, in the drawings, a symbol “○” with a symbol “·” therein means an arrow from the back of the plane of the sheet to the front thereof and a symbol “○” with a symbol “×” therein means an arrow from the front of the plane of the sheet to the back thereof.

In the following description using the drawings, members other than members required for description will be omitted as appropriate to facilitate understanding.

### Example 1

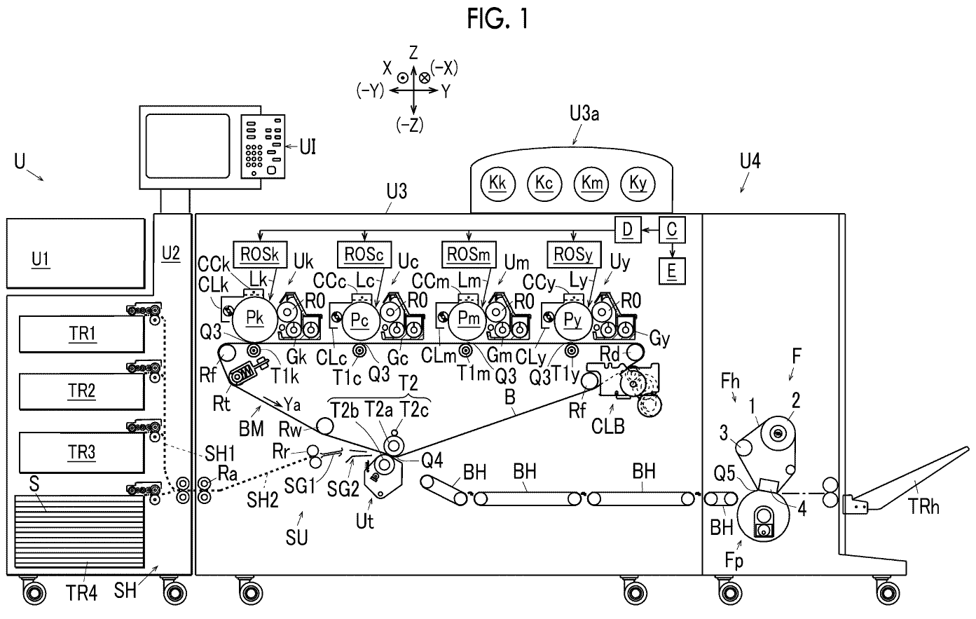

FIG. 1 is an overall explanatory view of an image forming apparatus according to Example 1 of the present invention.

In FIG. 1, a copying machine U that is an example of an image forming apparatus has a user interface UI that is an example of an operation unit, a scanner device U1 that is an example of an image reading device, a sheet feeding device U2, a printer unit U3 that is an example of image recording means, and a sheet discharge unit U4.

The user interface UI has a power button or a copy start key, a number-of-copies setting key, a numeric keypad, and the like as examples of an input unit, a display unit, and the like.

The scanner device U1 reads a document (not shown) to converts the read document into image information and inputs the image information to the printer unit U3.

The sheet feeding device U2 has a plurality of sheet feeding trays TR1, TR2, TR3, and TR4 which are examples of a sheet feed unit. Recording sheets S which are examples of a medium are accommodated in each of the sheet feeding trays TR1 to TR4. A sheet feeding passage SH1 which is an example of a transport passage for the medium extends from each of the sheet feeding trays TR1 to TR4 toward the printer unit U3.

In FIG. 1, the printer unit U3 has a control unit C that is an example of control means, a power source circuit E that supplies power to each member of the printer unit U3, and the like. The control unit C receives image information of a document read by the scanner device U1 and image information transmitted from a personal computer that is an example of an information transmission device (not shown) connected to the copying machine U.

The control unit C processes the received image information into yellow (Y), magenta (M), cyan (C), and black (K) printing information and outputs the processed image information to a laser drive circuit D that is an example of a drive circuit of a latent image writing device. The laser drive circuit D outputs a laser drive signal, which is input from the control unit C, to exposure devices ROSy, ROSm, ROSc, and ROSk that are examples of latent image forming means for each color at a time set in advance.

Image holder units Uy, Um, Uc, and Uk for Y, M, C, and K are disposed below the exposure devices ROSy to ROSk, respectively.

In FIG. 1, the image holder unit Uk for black (K) has a photoreceptor drum Pk that is an example of an image holding section, a charging corotron CCk that is an example of charging means, and a photoreceptor cleaner CLk that is an example of cleaning means for the image holding section. The image holder units Uy, Um, and Uc for the other colors Y, M, and C also have photoreceptor drums Py, Pm, and Pc, charging corotrons CCy, CCm, and CCc, and photoreceptor cleaners CLy, CLm, and CLc.

In Example 1, the photoreceptor drum Pk for a color of K, of which frequency of use is high and a surface is to be more worn, is configured to have a large diameter compared to diameters of the photoreceptor drums Py, Pm, and Pc for the other colors, so that response to high-speed rotation and a long service life are achieved.

After the photoreceptor drums Py to Pk are uniformly charged by the charging corotrons CCy to CCk, respectively, electrostatic latent images are formed on surfaces of the photoreceptor drums Py to Pk by laser beams Ly, Lm, Lc, and Lk which are examples of latent image writing light output from the exposure devices ROSy to ROSk. The electrostatic latent images on the surfaces of the photoreceptor drums Py to Pk are developed into toner images having the respective colors, that is, yellow (Y), magenta (M), cyan (C), and black (K) by developing devices Gy, Gm, Gc, and Gk which are examples of developing means.

The toner images on the surfaces of the photoreceptor drums Py to Pk are sequentially superimposed and transferred onto an intermediate transfer belt B, which is an example of an intermediate transfer section and an example of the image holding section, by primary transfer rolls T1y, T1m, T1c, and T1k, which is an example of a primary transfer section, in a primary transfer region Q3 so that a multicolor image, that is, a so-called color image is formed on the intermediate transfer belt B. The color image formed on the intermediate transfer belt B is transported to a secondary transfer region Q4.

In a case of only black image data, only the photoreceptor drum Pk and the developing device Gk for black (K) are used and only a black toner image is formed.

After the primary transfer, residual toner remaining on the surfaces of the photoreceptor drums Py to Pk is cleaned off by the photoreceptor cleaners CLy to CLk.

Each of the image holder units Uy to Uk and each of the developing devices Gy to Gk constitute a toner image forming member which is an example of image forming means.

A toner dispenser U3a that is an example of replenishment means is disposed on an upper portion of the printer unit U3, and toner cartridges Ky, Km, Kc, and Kk which are examples of developer accommodating means are attachably and detachably mounted on the toner dispenser U3a. In a case where toner is consumed in the developing devices Gy to Gk as images are formed, toner is supplied to each of the developing devices Gy to Gk from each of the toner cartridges Ky to Kk.

The intermediate transfer belt B disposed below the photoreceptor drums Py to Pk is stretched by an intermediate drive roll Rd that is an example of drive means for the intermediate transfer section, an intermediate tension roll Rt that is an example of tension application means which applies tension to the intermediate transfer belt B, an intermediate steering roll Rw that is an example of first bias correction means that corrects bias or meandering of the intermediate transfer belt B, a plurality of intermediate idler rolls Rf that are examples of driven means, and a backup roll T2a that is an example of a facing section of the secondary transfer region. The intermediate transfer belt B is supported to be rotatably movable in a direction of an arrow Ya by being driven by the intermediate drive roll Rd.

A belt module BM that is an example of an intermediate transfer device is configured by the intermediate drive roll Rd, the intermediate tension roll Rt, the intermediate steering roll Rw, the intermediate idler roll Rf, the backup roll T2a, the primary transfer rolls T1y to T1k, the intermediate transfer belt B, and the like. The belt module BM of Example 1 is configured by a unit that is attachable to and detachable from the printer unit U3 or is replaceable in the printer unit U3.

A secondary transfer unit Ut that is an example of transfer and transport means is disposed below the backup roll T2a. The secondary transfer unit Ut has a secondary transfer roll T2b that is an example of a transfer member. The secondary transfer roll T2b is disposed to face the backup roll T2a. The secondary transfer region Q4 is configured by a region where the secondary transfer roll T2b faces the intermediate transfer belt B. In addition, a contact roll T2c that is an example of contact means for voltage application is in contact with the backup roll T2a. A secondary transfer voltage having the same polarity as a charging polarity of toner is applied to the contact roll T2c from the power source circuit E controlled by the control unit C at a time set in advance.

A secondary transfer device T2 that is an example of a secondary transfer section is configured by the respective rolls T2a to T2c. In addition, a transfer device B + T1 + T2 that is an example of a transfer section is configured by the intermediate transfer belt B, the primary transfer rolls T1y to T1k, the secondary transfer device T2, and the like.

A sheet transport passage SH2 is disposed below the belt module BM. The recording sheet S fed from the sheet feeding passage SH1 of the sheet feeding device U2 is transported to the sheet transport passage SH2 by a transport roll Ra that is an example of transport means. The recording sheet S in the sheet transport passage SH2 is fed by a registration roll Rr that is an example of feeding means according to a time when a toner image is transported to the secondary transfer region Q4, is guided by sheet guides SG1 and SG2 that are examples of medium guide means and is transported to the secondary transfer region Q4.

The toner image on the intermediate transfer belt B is transferred onto the recording sheet S by the secondary transfer device T2 when passing through the secondary transfer region Q4. In a case of a color image, toner images superimposed and primarily transferred onto the surface of the intermediate transfer belt B are collectively and secondarily transferred onto the recording sheet S.

The intermediate transfer belt B after the secondary transfer is cleaned by a belt cleaner CLB that is an example of cleaning means of the intermediate transfer section.

The recording sheet S to which a toner image is secondarily transferred is sent to a medium transport belt BH that is an example of the transport means. The medium transport belt BH transports the recording sheet S to a fixing device F that is an example of a belt unit and an example of a fixing section. The fixing device F has a heating unit Fh that is an example of a first fixing section and a pressurizing unit Fp that is an example of a second fixing section. A fixing region Q5 is formed of a region where the heating unit Fh and the pressurizing unit Fp face each other and are in contact with each other.

The toner image on the recording sheet S is heated and fixed by the fixing device F when passing through the fixing region Q5. The recording sheet S to which the toner image is fixed by the fixing device F is discharged to a discharge tray TRh that is an example of a discharge unit.

A sheet transport passage SH is configured by reference numerals SH1, SH2, and the like. In addition, a sheet transport device SU is configured by reference numerals SH, Ra, Rr, SG1, SG2, BH, and the like.

### Description of Fixing Device

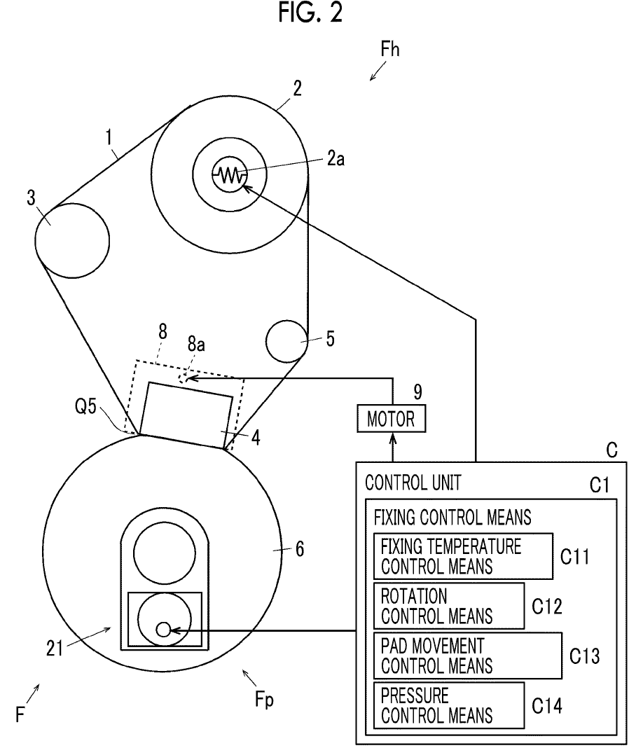

FIG. 2 is an enlarged view of the fixing device of Example 1.

In FIG. 1, the heating unit Fh of the fixing device F of Example 1 has a fixing belt 1 that is an example of an endless section. The fixing belt 1 is stretched by a heating roll 2 that is an example of a heating section, a steering roll 3 that is an example of bias correction means, a heating pad 4 that is an example of a support section, and a tension roll 5 that is an example of the tension application means.

The fixing belt 1 can be made of any well-known material in the related art, and it is preferable that a substrate thereof is made of, for example, a polyimide-based material having high stiffness. In addition, it is preferable that a surface layer of the fixing belt 1 is made of, for example, a material such as a fluororesin having high releasability of molten toner, paper powder, or the like.

A heater 2a that is an example of the heating section is built in the heating roll 2 of Example 1. The heating roll 2 heated by the heater 2a heats the fixing belt 1 that is in contact therewith.

The steering roll 3 corrects the meandering or bias of the fixing belt 1.

The heating pad 4 supports the fixing belt 1 with a lower surface 4a that is an example of a support surface. The heating pad 4 is disposed to face a pressurizing roll 6 of the pressurizing unit Fp. The fixing region Q5 is configured by a region between the fixing belt 1 supported by the heating pad 4 and the pressurizing roll 6 that is an example of the facing section. Accordingly, unfixed images on the recording sheet S passing through the fixing region Q5 are fixed to the recording sheet S by being pressurized while being heated.

The tension roll 5 applies tension to the fixing belt 1.

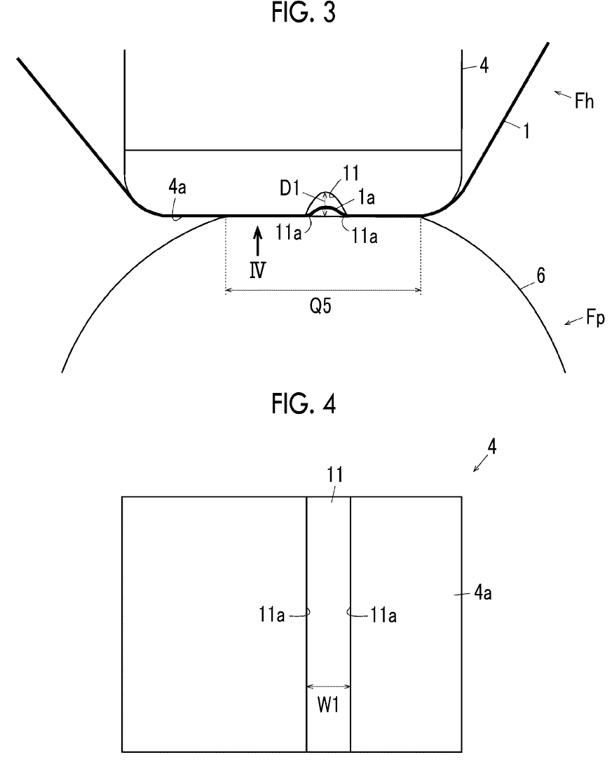

FIG. 3 is an enlarged view of a major part of a portion of the support section of Example 1.

FIG. 4 is a view of the support section of Example 1 viewed from an arrow IV direction.

In FIGS. 3 and 4, a groove 11 is formed in the lower surface 4a of the heating pad 4 of Example 1. The groove 11 is formed along the front-rear direction, that is, a width direction of the recording sheet S.

A depth D1 of the groove 11 is formed such that a portion 1a of the fixing belt 1 passing through the groove 11 is deformed toward an inside of the groove 11, and the deformed portion 1a is not in contact with a bottom portion of the groove 11. Therefore, the depth D1 of the groove 11 is set to a sufficient depth such that according to the amount of the portion 1a entering the groove 11 determined by stiffness of the fixing belt 1 and a pressure from the pressurizing roll 6, the entering portion 1a is not in contact with the bottom portion of the groove 11.

In addition, a portion of a corner 11a at a boundary between the groove 11 and the lower surface 4a of the heating pad 4 is formed in a chamfered shape, that is, a so-called R-shape. Therefore, an excessive load and stress acting on the fixing belt 1 at a portion of the corner 11a are suppressed compared to a case where the corner 11a does not have the chamfered shape. Accordingly, wear and a decrease in the life of the fixing belt 1 are suppressed. The size of the R-shape varies depending on the stiffness of the fixing belt 1 and the pressure of the pressurizing roll 6. However, in a case where a surface pressure on the lower surface 4a is approximately 5kgf/cm², for example, it is preferable that a radius R is approximately 0.3mm.

Further, the groove 11 of Example 1 is formed such that a width W1 in a Y-direction (a movement direction of the fixing belt 1) is a constant width over the entire region of the fixing belt 1 in an X-direction (a width direction of the fixing belt 1). The width W1 varies depending on the stiffness of the fixing belt 1 and the pressure of the pressurizing roll 6. However, in a case where a surface pressure on the lower surface 4a is approximately 5kgf/cm², for example, it is preferable that the width W1 is approximately 2mm. This is because in a case where the width W1 is too small, the fixing belt 1 hardly enters the groove 11, and in a case where the width W1 is too large, the fixing belt 1 that enters the groove 11 is easily bent, which easily causes a decrease in the life due to stress of bending stress.

In addition, the groove 11 of Example 1 is disposed at a position on the downstream side of the center of the fixing region Q5 in a transport direction of the recording sheet S, that is, in the movement direction of the fixing belt 1. In the fixing region Q5, a developer on the surface of the recording sheet S receives heat and melts. Therefore, the developer is in a state of being more molten on the downstream side than an upstream side of the fixing region Q5, and a viscosity is brought into a decreased state. The groove 11 of Example 1 is disposed at a position on the downstream side of the fixing region Q5 where the viscosity of the developer is decreased.

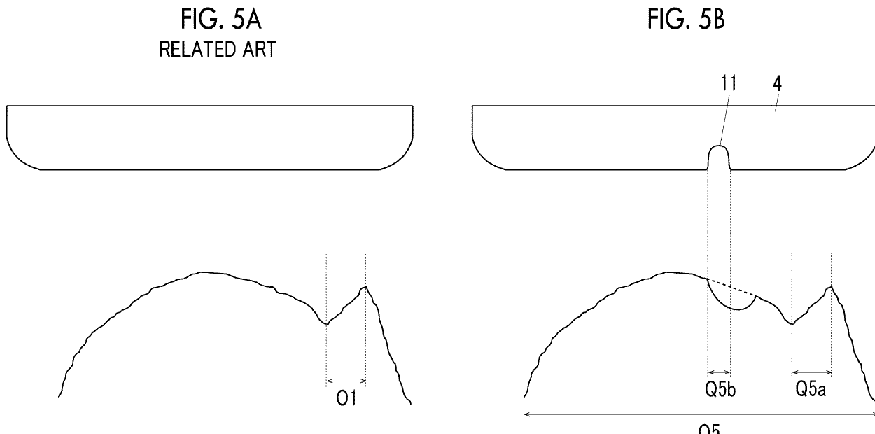

FIGS. 5A and 5B are explanatory views of a pressure distribution in the fixing region of Example 1, FIG. 5A is an explanatory view of a pressure distribution of a configuration of the related art, and FIG. 5B is an explanatory view of a pressure distribution of Example 1.

The groove 11 of Example 1 is disposed at a position on the upstream side in the transport direction of the recording sheet S with respect to a region of the pressure distribution for peeling off the recording sheet S discharged from the fixing region Q5 (peeling pressure region Q5a). In FIG. 5A, in the configuration of the related art where the groove 11 is not formed, the pressure is raised at a downstream end portion 01 of the fixing region such that the recording sheet is peeled off from the fixing belt such that the recording sheet is not wound around the fixing belt. In a case where the rise in pressure is large, peelability is high. However, in a case where the pressure rise (pressure difference) is too large, the image quality, a sheet wrinkle, and a curl of sheet deteriorate. In FIG. 5B, in Example 1, the groove 11 is formed at a position on the upstream side of the peeling pressure region Q5a. As shown in FIG. 5B, the pressure locally decreases in a portion Q5b where the groove 11 is formed. In a case where the local decrease in the pressure occurs in the peeling pressure region Q5a, the subsequent pressure rise is too rapid. Therefore, in Example 1, the image quality decrease and the like are suppressed while maintaining the peelability, compared to a case where the groove 11 is disposed in the peeling pressure region Q5a.

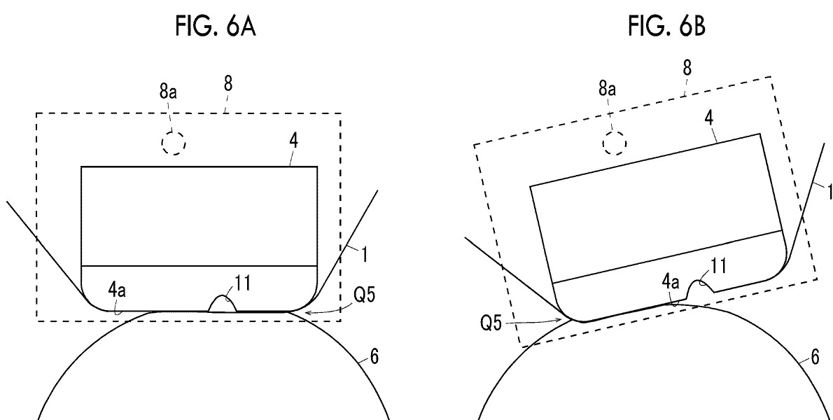

FIG. 6 is an explanatory view of the position of the support section of Example 1, FIG. 6A is an explanatory view of a high glossiness position, and FIG. 6B is an explanatory view of a non-high glossiness position.

In Example 1, the heating pad 4 is supported by the movable bracket 8 that is an example of a moving section. The movable bracket 8 of Example 1 is supported to be rotatable about a rotation center 8a. In FIG. 6, the movable bracket 8 of Example 1 is movable between the high glossiness position (see FIG. 6A) that is an example of a first position and the non-high glossiness position (see FIG. 6B) that is an example of a second position. In FIG. 6A, at the high glossiness position, the groove 11 is in a state of being disposed in the fixing region Q5. In FIG. 6B, at the non-high glossiness position, the groove 11 is in a state of being disposed outside the fixing region Q5.

The movable bracket 8 is rotatably movable as driving from a motor 9 that is an example of a driving source via a drive transmission system such as a gear (not shown).

In addition, the pressurizing roll 6 is configured to be adjustable a force of pressing against the heating pad 4 with a pressure adjusting mechanism 21.

The heating unit Fh of Example 1 is configured by the fixing belt 1, the heating roll 2, the steering roll 3, the heating pad 4, the tension roll 5, the movable bracket 8, the motor 9, a spring that presses the tension roll 5 (not shown), and the like, which are shown in the drawing.

In addition, the pressurizing unit Fp of Example 1 is configured by the pressurizing roll 6, the pressure adjusting mechanism 21, and the like.

### Description of Control Unit of Example 1

In FIG. 2, the control unit (controller) C of the copying machine U has an input/output interface I/O that inputs and outputs signals to and from the outside. In addition, the control unit C has a read-only memory (ROM) in which a program, information, and the like for necessary processing are stored. In addition, the control unit C has a random access memory (RAM) that temporarily stores necessary data. In addition, the control unit C has a central processing unit (CPU) that performs processing corresponding to the program stored in the ROM or the like. Therefore, the control unit C of Example 1 is configured by a small information processing device, that is, a so-called microcomputer. Accordingly, the control unit C can realize various functions by executing the program stored in the ROM or the like.

Signals from a signal output element are input to the control unit C of Example 1, and the control unit C performs control by outputting the signals to a control target element.

### Functions of Control Unit C

The control unit C of Example 1 has the following functional means (functional modules, program modules).

Fixing control means C1 has fixing temperature control means C11, rotation control means C12, pad movement control means C13, and pressure control means C14. The fixing control means C1 controls the operation and stop of the fixing device F.

The fixing temperature control means C11 controls ON/OFF of the heater 2a to maintain the temperature of the fixing belt 1 at a fixing temperature determined in advance. The fixing temperature control means C11 starts the control of the heater 2a such that the temperature reaches the fixing temperature in a case where a job, which is an image forming operation, is started. In a case where the job ends, the fixing temperature control means C11 turns off the heater 2a. In a case where “high glossiness” is set, the fixing temperature control means C11 of Example 1 performs control such that the fixing temperature is a higher temperature and performs control such that the glossiness and gloss are high compared to a case where “non-high glossiness” is set.

The rotation control means C12 controls the rotation of the pressurizing roll 6. Therefore, the rotation of the fixing belt 1 to be driven and rotated is also indirectly controlled with the rotation of the pressurizing roll 6. The rotation control means C12 of Example 1 drives the pressurizing roll 6 in a case where the job is started, and stops the pressurizing roll 6 in a case where the job ends. In Example 1, an aspect in which the pressurizing roll 6 is driven and the fixing belt 1 is driven and rotated has been described as an example, but the present invention is not limited thereto. For example, an aspect in which the heating roll 2 is driven and a pressurizing roll 6 side is driven and rotated can also be adopted.

The pad movement control means C13 controls the motor 9 such that the heating pad 4 is moved. The pad movement control means C13 of Example 1 moves the movable bracket 8 according to setting of glossiness of printing setting by an input of a user, that is, setting of either “high glossiness” or “non-high glossiness (normal)” and moves the movable bracket 8 between the high glossiness position and the non-high glossiness position. That is, in a case where the high glossiness is set, the heating pad 4 is moved to the high glossiness position, and in a case where the non-high glossiness is set, the heating pad 4 is moved to the non-high glossiness position.

The pressure control means C14 controls the pressure adjusting mechanism 21 to control a force of pressing the pressurizing roll 6. In a case where “high glossiness” is set, the pressure control means C14 of Example 1 performs control such that the pressing force is a high pressure and performs control such that the glossiness and gloss are high compared to a case where “non-high glossiness” is set.

### Action of Example 1

In the fixing device F of Example 1 having the configuration, the recording sheet S passes through the fixing region Q5 in a case of fixing an image of the recording sheet S. In a case of the high glossiness setting, a fixing temperature and fixing pressure are in a high state compared to a case of non-high glossiness setting. Therefore, in the high glossiness setting, the developer is likely to be in a more molten state, and a pressure applied to the developer is also high. As the number of minute roughnesses on a surface of the developer after fixing decreases, the surface of the developer becomes close to a mirror surface, and glossiness and gloss increase. Therefore, in a case where the developer is more molten, the number of minute roughnesses is likely to be decreased, and as the pressure received increases, the number of minute roughnesses is likely to be decreased.

In Example 1, the groove 11 is formed at a position in the middle of the fixing region Q5. At the position of the groove 11, the portion 1a of the fixing belt 1 is in a form of entering the groove 11 locally and temporarily. Therefore, a distortion occurs between the fixing belt 1 and the recording sheet S. Therefore, the recording sheet S is driven to rotate by the pressurizing roll 6 and the rotation speed is maintained, but a fixing belt 1 side is distorted and shifted at the portion 1a that enters a groove 11 side between the fixing belt 1 and the recording sheet S. Herein, it is estimated that the pressure is released at an upstream portion of the groove 11 to increase a sheet speed, the pressure is applied again at a downstream portion of the groove 11, and a brake is applied to the recording sheet S to reduce the sheet speed. Therefore, it is estimated that at a portion of passing through the groove 11, the fixing belt 1 rubs a developer on the surface of the recording sheet S due to a speed difference between the fixing belt 1 and the recording sheet S.

Accordingly, in a case where the developer on the surface of the recording sheet S on the fixing belt 1 side passes through a portion of the groove 11, the surface of the developer receives a force to be rubbed against the surface of the fixing belt 1. Therefore, the number of minute roughnesses on the surface of the developer after fixing is likely to decrease. Accordingly, gloss increases. Therefore, in Example 1 in which the groove 11 is included, it is possible to improve glossiness of an image compared to a case where the lower surface 4a of the heating pad 4 that supports the fixing belt 1 on the fixing region Q5 side is smooth.

In JP2019-101314A ([0038] to [0047], [0055] to [0086], and FIG. 3 and FIGS. 6 - 11), the pressure distribution is set such that the pressure is maximum on an inlet side in a sheet passing direction. However, there is a problem in which immediately after the developer starts to melt at an inlet, and the gloss cannot be improved very much. In addition, in a case where the pressure distribution on an outlet side decreases, there is also a problem in which the peelability of the sheet is decreased.

In JP2016-177208A ([0020] to [0052] and FIGS. 2 - 6), an interval between two members, a fixing roll (611) and a peeling pad (64), is changed. However, in a configuration where the two members are used, as described in FIG. 6 of JP2016-177208A ([0020] to [0052] and FIGS. 2 - 6), a recess and a depression in the pressure distribution are too large. Accordingly, there is a problem in which an image is shifted or gloss unevenness is generated.

On the contrary, in Example 1, at the groove 11 formed in the lower surface 4a, it is possible to improve glossiness while maintaining the peelability compared to JP2019-101314A ([0038] to [0047], [0055] to [0086], and FIG. 3 and FIGS. 6 - 11). In addition, compared to JP2016-177208A ([0020] to [0052] and FIGS. 2 - 6), depression of the pressure distribution is not too large, the occurrence of a fixing failure such as image blurring is suppressed, and the glossiness can be improved.

In addition, in the groove 11 of Example 1, the depth D1 is set to a depth at which the deformed portion 1a is not in contact with the bottom portion of the groove 11. Therefore, in a case where the fixing belt 1 comes into contact with the bottom portion of the groove 11, the fixing belt 1 may be insufficiently strained. However, in Example 1 in which the fixing belt 1 does not come into contact with the bottom portion of the groove 11, the fixing belt 1 can be sufficiently strained. Therefore, glossiness can be sufficiently improved compared to a case of coming into contact.

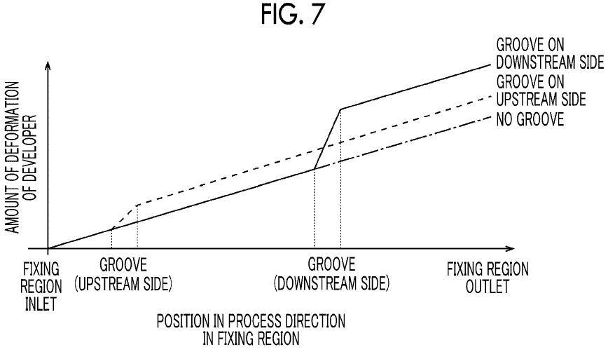

FIG. 7 is a graph showing a relationship between the amount of deformation of the developer in the fixing region of Example 1 and a position in the fixing region in the transport direction.

Further, the groove 11 of Example 1 is disposed at a position on the downstream side of the center of the fixing region Q5. In a case where the groove 11 is disposed on the upstream side of the fixing region Q5, the inclination of the amount of deformation of the developer is gentle compared to the downstream side. That is, as shown by a broken line in FIG. 7, in a case where the groove 11 is disposed on the upstream side, the developer does not melt very much, the viscosity is high, and the amount of deformation of the developer, that is, an inclination that raises ease of leveling out roughness, at the portion of the groove 11, is not likely to be leveled out. On the other hand, as shown by a solid line in FIG. 7, in a case where the groove 11 is disposed on the downstream side, the inclination at the portion of the groove 11 is increased. Accordingly, it is possible to further improve glossiness in a case where the groove 11 is disposed on the downstream side compared to a case where the groove 11 is disposed on the upstream side of the fixing region Q5.

In addition, in Example 1, the heating pad 4 moves to the high glossiness position in the “high glossiness” setting and moves to the non-high glossiness position in the “normal: non-high glossiness” setting. Therefore, in a case where an image having a low glossiness is to be obtained, the groove 11 can be moved to the outside of the fixing region Q5 such that the glossiness is not increased.

### Modification Examples of Example 1

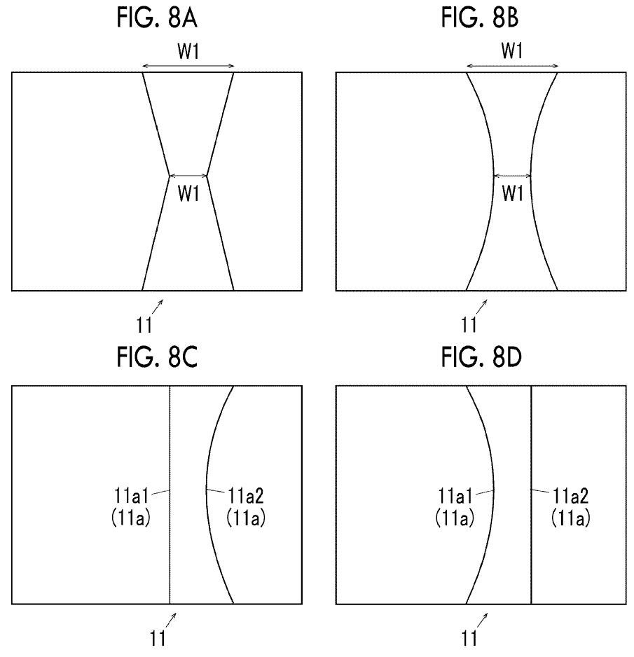

FIGS. 8A - 8D are explanatory views of modification examples of Example 1, FIG. 8A is an explanatory view of Modification Example 1, FIG. 8B is an explanatory view of Modification Example 2, FIG. 8C is an explanatory view of Modification Example 3, and FIG. 8D is an explanatory view of Modification Example 4.

The groove 11 of Example 1 is formed such that the width W1 is a constant width over the entire region of the fixing belt 1 in the X-direction (width direction) but is not limited thereto. For example, as shown in FIGS. 8A - 8D, a shape such that the width W1 increases toward an outside in a belt width direction may be adopted. That is, as shown in FIG. 8A, a configuration where the width W1 increases linearly from the center toward the outside in the belt width direction can be adopted. In addition, as shown in FIG. 8B, a configuration where the width W1 increases in a curved manner from the center toward the outside in the belt width direction can be adopted. In addition, as shown in FIG. 8C, it is also possible to adopt an aspect in which a corner 11a1 of the groove 11 on the upstream side has a linear shape along the belt width direction, and a corner 11a2 on the downstream side has a curved shape toward the outside in the belt width direction, so that the width W1 increases. In addition, as shown in FIG. 8D, the corners 11a1 and 11a2 can be in a relationship of being opposite to each other to the relationship in FIG. 8C.

In a case where the width W1 increases toward the outside in the belt width direction, the fixing belt 1 and the recording sheet S receive a force toward the outside in the belt width direction in a case where the fixing belt 1 and the recording sheet S pass through the portion of the groove 11. Therefore, in a case where a force toward an inside in the width direction is received, wrinkles may be generated in the fixing belt 1 and the recording sheet S. However, by configuring the groove 11 as shown in FIGS. 8A-8D, generation of the wrinkles can be suppressed.

### Modification Examples

The Examples of the present invention has been described in detail above, but the present invention is not limited to the Examples described above and can have various modifications without departing from the scope of the present invention described in claims. Modification Examples (H01) to (H010) of the present invention are given as examples below.

(H01) The copying machine U that is an example of the image forming apparatus has been given as an example in the Examples described above, but without being limited thereto, for example, the image forming apparatus can also be configured by a FAX, a printer, and a multifunction machine.

(H02) A configuration where developers for four colors are used has been given as an example of the image forming apparatus in the Example described above, but without being limited thereto, for example, the present invention can also be applied to a monochromatic image forming apparatus and an image forming apparatus for multiple colors of three colors or less or five colors or more.

(H03) In the Examples, the shape of the heating pad 4 is not limited to the shape given as an example in the Examples. The shape of the heating pad 4 can be any shape such as a shape in which a surface on the fixing region Q5 side is a curved surface.

(H04) An aspect in which the heater 2a that is a heating section is built in the heating roll 2 has been given as an example in the Examples described above, but the present invention is not limited thereto. An aspect in which the heater is built in the heating pad 4 can also be adopted.

(H05) In the Examples, an aspect in which the movable bracket 8 rotatably moves is given as an example. However, the present invention is not limited thereto. An aspect in which the movable bracket 8 moves in parallel can also be adopted. In addition, in an image forming apparatus in which the glossiness cannot be selected, a configuration where the heating pad 4 does not move can also be adopted.

(H06) In the Examples, the depth D1 of the groove 11 is, for example, desirably a depth at which the fixing belt 1 does not come into contact with a bottom surface but can also be a depth at which the fixing belt 1 comes into contact with the bottom surface.

(H07) In the Examples, for example, the corner 11a desirably has a chamfered shape, but a configuration without the chamfered shape can also be adopted.

(H08) In the Examples, the groove 11 is desirably disposed at a position on the downstream side of the fixing region Q5, but the present invention is not limited thereto. An aspect in which the groove 11 is provided at a position of a central portion of the fixing region Q5 or is provided in an upstream portion except for an upstream end can also be adopted.

(H09) In the Examples, the groove 11 is desirably disposed at a position on the upstream side of the peeling pressure region Q5a, but the present invention is not limited thereto. In a case where a risk of an image quality decrease or the like is low due to setting of the pressure or the like of the pressurizing roll 6, an aspect in which the groove 11 is disposed in the peeling pressure region Q5a can also be adopted.

(H010) In the Examples, for example, it is desirably to change the fixing temperature and the fixing pressure according to setting of glossiness, but the fixing temperature and the fixing pressure may be kept constant regardless of the setting of glossiness.

### Supplementary Notes

(((1))) A fixing device comprising:

a first fixing section that has an endless section that rotates, a support section which is disposed to correspond to a fixing region through which a medium passes and which supports the endless section, and a heating section which heats the fixing region to increase a temperature of the fixing region to a fixing temperature determined in advance; and

a second fixing section that has a facing section which is pressed against the support section with the endless section nipped between the facing section and the support section in the fixing region,

wherein a groove is formed in a support surface of the support section on a fixing region side along a width direction of the medium.

(((2))) The fixing device according to (((1))),

wherein a depth of the groove is formed such that a portion of the endless section, which passes through the groove, is deformed toward an inside of the groove and the portion of the endless section, which is deformed toward the inside of the groove, does not come into contact with a bottom portion of the groove.

(((3))) The fixing device according to (((1))) or (((2))),

wherein a portion of a corner at a boundary between the support surface and the groove has a chamfered shape.

(((4))) The fixing device according to any one of (((1))) to (((3))),

wherein the groove is formed to have a width in a transport direction, which increases toward an outside in the width direction of the medium.

(((5))) The fixing device according to any one of (((1))) to (((4))),

wherein the groove is disposed at a position on a downstream side of a center of the fixing region in a transport direction of the medium.

(((6))) The fixing device according to (((5))),

wherein the groove is disposed at a position on an upstream side of a region of a pressure distribution for peeling off the medium discharged from the fixing region in the transport direction of the medium.

(((7))) The fixing device according to any one of (((1))) to (((6))), further comprising:

a moving section that moves a position of the support section between a first position where the groove is disposed in the fixing region and a second position where the groove is disposed outside the fixing region.

(((8))) The fixing device according to (((7))),

wherein the fixing device includes the moving section that moves the support section to the first position in a case where high glossiness determined in advance is selected and that moves the support section to the second position in a case where the high glossiness is not selected.

(((9))) The fixing device according to (((8))),

wherein the fixing device includes

the heating section that increases the fixing temperature in a case where the high glossiness is selected, and

the second fixing section that increases a pressing force of the facing section in a case where the high glossiness is selected.

(((10))) An image forming apparatus comprising:

an image holding section that holds an image on a surface of the image holding section;

a transfer section that transfers the image on the image holding section to a medium; and

the fixing device according to any one of (((1))) to (((9))) that fixes the image transferred to the medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
a first fixing section that has an endless section that rotates, a support section which is disposed to correspond to a fixing region through which a medium passes and which supports the endless section, and a heating section which heats the fixing region to increase a temperature of the fixing region to a fixing temperature determined in advance; and
a second fixing section that has a facing section which is pressed against the support section with the endless section nipped between the facing section and the support section in the fixing region,
wherein a groove is formed in a support surface of the support section on a fixing region side along a width direction of the medium.

2. The fixing device according to claim 1,
wherein a depth of the groove is formed such that a portion of the endless section, which passes through the groove, is deformed toward an inside of the groove and the portion of the endless section, which is deformed toward the inside of the groove, does not come into contact with a bottom portion of the groove.

3. The fixing device according to claim 1,
wherein a portion of a corner at a boundary between the support surface and the groove has a chamfered shape.

4. The fixing device according to claim 1,
wherein the groove is formed to have a width in a transport direction, which increases toward an outside in the width direction of the medium.

5. The fixing device according to claim 1,
wherein the groove is disposed at a position on a downstream side of a center of the fixing region in a transport direction of the medium.

6. The fixing device according to claim 5,
wherein the groove is disposed at a position on an upstream side of a region of a pressure distribution for peeling off the medium discharged from the fixing region in the transport direction of the medium.

7. The fixing device according to claim 1, further comprising:
a moving section that moves a position of the support section between a first position where the groove is disposed in the fixing region and a second position where the groove is disposed outside the fixing region.

8. The fixing device according to claim 7,
wherein the fixing device includes the moving section that moves the support section to the first position in a case where high glossiness determined in advance is selected and that moves the support section to the second position in a case where the high glossiness is not selected.

9. The fixing device according to claim 8,
wherein the fixing device includes
the heating section that increases the fixing temperature in a case where the high glossiness is selected, and
the second fixing section that increases a pressing force of the facing section in a case where the high glossiness is selected.

10. An image forming apparatus comprising:
an image holding section that holds an image on a surface of the image holding section;
a transfer section that transfers the image on the image holding section to a medium; and
the fixing device according to claim 1 that fixes the image transferred to the medium.

11. An image forming apparatus comprising:
an image holding section that holds an image on a surface of the image holding section;
a transfer section that transfers the image on the image holding section to a medium; and
the fixing device according to claim 2 that fixes the image transferred to the medium.

12. An image forming apparatus comprising:
an image holding section that holds an image on a surface of the image holding section;
a transfer section that transfers the image on the image holding section to a medium; and
the fixing device according to claim 3 that fixes the image transferred to the medium.

13. An image forming apparatus comprising:
an image holding section that holds an image on a surface of the image holding section;
a transfer section that transfers the image on the image holding section to a medium; and
the fixing device according to claim 4 that fixes the image transferred to the medium.

14. An image forming apparatus comprising:
an image holding section that holds an image on a surface of the image holding section;
a transfer section that transfers the image on the image holding section to a medium; and
the fixing device according to claim 5 that fixes the image transferred to the medium.

15. An image forming apparatus comprising:
an image holding section that holds an image on a surface of the image holding section;
a transfer section that transfers the image on the image holding section to a medium; and
the fixing device according to claim 6 that fixes the image transferred to the medium.

16. An image forming apparatus comprising:
an image holding section that holds an image on a surface of the image holding section;
a transfer section that transfers the image on the image holding section to a medium; and
the fixing device according to claim 7 that fixes the image transferred to the medium.

17. An image forming apparatus comprising:
an image holding section that holds an image on a surface of the image holding section;
a transfer section that transfers the image on the image holding section to a medium; and
the fixing device according to claim 8 that fixes the image transferred to the medium.

18. An image forming apparatus comprising:
an image holding section that holds an image on a surface of the image holding section;
a transfer section that transfers the image on the image holding section to a medium; and
the fixing device according to claim 9 that fixes the image transferred to the medium.
